(19) United States
(12) Patent Application Publication
(10) Pub. No.: US 2010/0142855 A1
(43) Pub. Date: Jun. 10, 2010

(54) IMAGE PROCESSING SYSTEM WITH MORPHOLOGICAL MACRO CELL

(75) Inventors: Eva Dokladalova, Dammarie Les Lys (FR); Philippe Fauvel, Plaisir (FR); Stéphane Guyetant, Le Plessis Robinson (FR); Christophe Clienti, Joinville Le Pont (FR)

Correspondence Address: WEINGARTEN, SCHURGIN, GAGNEBIN & LEBOVICI LLP, TEN POST OFFICE SQUARE, BOSTON, MA, 02109, US

(73) Assignee: COMMISSARIAT A L'ENERGIE ATOMIQUE, Paris (FR)

(21) Appl. No.: 12/516,432

(22) PCT Filed: Nov. 27, 2007
(86) PCT No.: PCT/FR07/52404

§ 371 Date: Jan. 6, 2010

(30) Foreign Application Priority Data
Nov. 28, 2006 (FR) 0655151

(51) Int. Cl. G06K 9/60

(52) U.S. Cl. 382/308

(57) ABSTRACT

The image processing system using morphological macrocells comprises: an image acquisition device, a set of memories, a computation block, and a control system. The computation block includes k morphological macrocells (50) each including a set of basic morphological cells (51, 52, 61, 62) organized into parallel branches (f, g), each cell (51, 52, 61, 62) executing a basic erosion, dilation or identity function based on the use of linear structuring elements, the functionality of each morphological cell and the size of the structuring elements being programmable dynamically and the parallel streams coming from the basic morphological cells being combined at the output by an arithmetic and logic unit (70). At least one system for parallelizing the data for processing a plurality of lines, respectively a plurality of columns, in parallel breaks down a word into p parallel data streams and is connected to the p morphological macrocell inputs. At least one system for reconstructing the image from z parallel output streams of the k morphological macrocells is connected to synchronous outputs of the morphological macrocells. The basic morphological cells (51, 52, 61, 62) and the morphological macrocells (50) are provided with a control mechanism able to communicate with the control system to stop selectively execution of processing as a function of the availability of the data and thereafter to resume processing without losing data in the pipeline.

The present invention relates to an image processing system using morphological macrocells.

The present invention aims to use non-linear image processing techniques based in particular on the theory of mathematical morphology and in particular erosion and dilation operations for fast processing of linear structuring elements of large size (for example from 3 pixels to 256 pixels).

The invention relates more particularly to a system for detecting objects with repetitive patterns consisting of letters, digits or symbols.

The basic principle of erosion and dilation relies on “min” and “max” operations. It compares the image to be analyzed to a structuring element of known geometry that is moved so that its origin passes through all the positions of the image, to highlight certain features of the image.

The center (B) of the structuring element determines the value where the “min” or the “max” will be stored as a function of a given neighborhood.

Erosion of an image f(x) by a structuring element B is defined in the following manner:

ε_{B}(f(x))=inf{f(x−y)), y∈B} (1)

The term f(x−y) represents moving the structuring element in translation over the image. The term f(x) is assigned the minimum value that it assumes in the domain of the structuring element B on each new movement of B.

Dilation of an image is the dual of erosion. It is defined in the following manner:

β_{B}(f(x))=sup{f(x−y)), y∈B} (2)

The term f(x) is assigned the maximum value that it assumes in the domain of B on each new movement of B.

Composite transformations are constructed by combining and chaining basic transformations. With operations such as subtraction, supremum, or infimum, a great variety of processing operations can be carried out.

The gradient results from applying subtraction to the original image and an eroded or dilated image. An open function is executed by dilation of the original image followed by erosion of the result. A close function is defined as a dual transformation.

A more advanced transformation is used to construct alternating sequential filters. The principle is to chain open and close functions alternately with increasing sizes of B.

A composite “top hat” transformation is defined in two ways: the close or black top hat (BTH) function and the open or white top hat (WTH) function. The WTH is equal to the difference between the original image and the outcome of the open function. It retains the objects of the image that are pale above a certain threshold. The BTH is equal to the difference between the outcome of the close function and the original image. It retains the objects of the image that are dark below a certain threshold.

The invention aims in particular to optimize data processing in a stream of images such as a stream of video signals and to facilitate adaptation of the image processing effected.

Using linear structuring elements means that parallelism can be applied at the rows/columns level of an image because each row/column is processed independently of the others.

Implementation is advantageously based on a process independent of the size of the structuring element with a constant execution time.

The invention therefore consists of an image processing system using morphological macrocells, characterized in that it comprises:
an image acquisition device for creating a grayscale digital image including a matrix of m lines and n columns coded on b bits, where m, n, and b are integers;
a set of memories;
a dynamically reconfigurable computation block for performing image processing, the computation units and the data paths being reconfigurable during execution between individual processes; and
a control system for transferring data between the image acquisition device and the set of memories and for managing the control of p parallel streams of data to the computation block and for sending the data with dedicated addresses as a function of the requirements of the block, where p is an integer;

in that the computation block includes:
an integer number k greater than 1 of morphological macrocells each including a set of basic morphological cells organized into b parallel branches with an integer number e of stages, each cell performing a basic erosion, dilation or identity function based on the use of linear structuring elements, the functionality of each morphological cell and the size of the structuring elements being programmable dynamically and the parallel streams coming from the basic morphological cells being combined at the output by an arithmetic and logic unit;
at least one system for parallelizing the data for processing a plurality of lines, respectively a plurality of columns, in parallel, including two buffer modules and a demultiplexer pipelined over a set of s synchronous stages to break down a word into p parallel data streams and connected to the p inputs of the morphological macrocells; and
at least one system for reconstructing the image from an integer number z of parallel output streams of the k morphological macrocells, including two buffer modules and a multiplexer pipelined over a set of s′ stages and connected to synchronous outputs of the morphological macrocells;

and in that the basic morphological cells and the morphological macrocells are provided with a control mechanism able to communicate with the control system to stop selectively execution of processing as a function of the availability of the data and thereafter to resume processing without losing data in the pipeline.

The system advantageously includes an integer number f of data parallelization systems and image reconstruction systems to enable processing over f×p parallel streams of data.

According to one preferred feature, the morphological macrocells are pipelined over a plurality of branches with a plurality of stages, the outputs being combined by an arithmetic and logic unit.

In one particular embodiment, each morphological cell includes first and second processing units for carrying out processing in first and second passes in different processing directions and there is a buffer module between the first and second processing units.

Each of the first and second processing units then preferably includes a propagation unit, an edge effect and dedicated processing management unit, and a delay line.

A morphological macrocell has at least two branches with two chained morphological cells each providing erosion, dilation, and/or identity functions and an arithmetic and logic unit for defining by reconfiguration composite operators of close, open, open top hat, close top hat, and/or gradient type.

Thus the erosion and dilation functions are advantageously complemented by the identity function and an arithmetic/logic unit for creating composite operators for executing filtering, image enhancement, contour extraction, and object detection processes.

The invention relates in particular to the use of such an image processing system using morphological macrocells and including at least two chained morphological macrocells combined with arithmetic/logic units to perform image processing operations such as gradient, non-linear filter, alternating sequential filter, and contrast modification operations.

The invention relates more particularly to a system for detecting objects carrying repetitive patterns consisting of letters, digits, or symbols, characterized in that it includes a reconfigurable image processing system using morphological macrocells, a first image processing module, and a second image processing module.

In one particular embodiment the first image processing module includes a first open/close module, a second open/close module, an arithmetic/logic unit for performing comparisons with thresholds, an intersection module, and a line open module.

The second image processing module includes an open/close module.

The system of the invention is advantageously applied to detecting number plates.

Other features and advantages of the invention emerge from the following description of particular embodiments given with reference to the appended drawings in which:

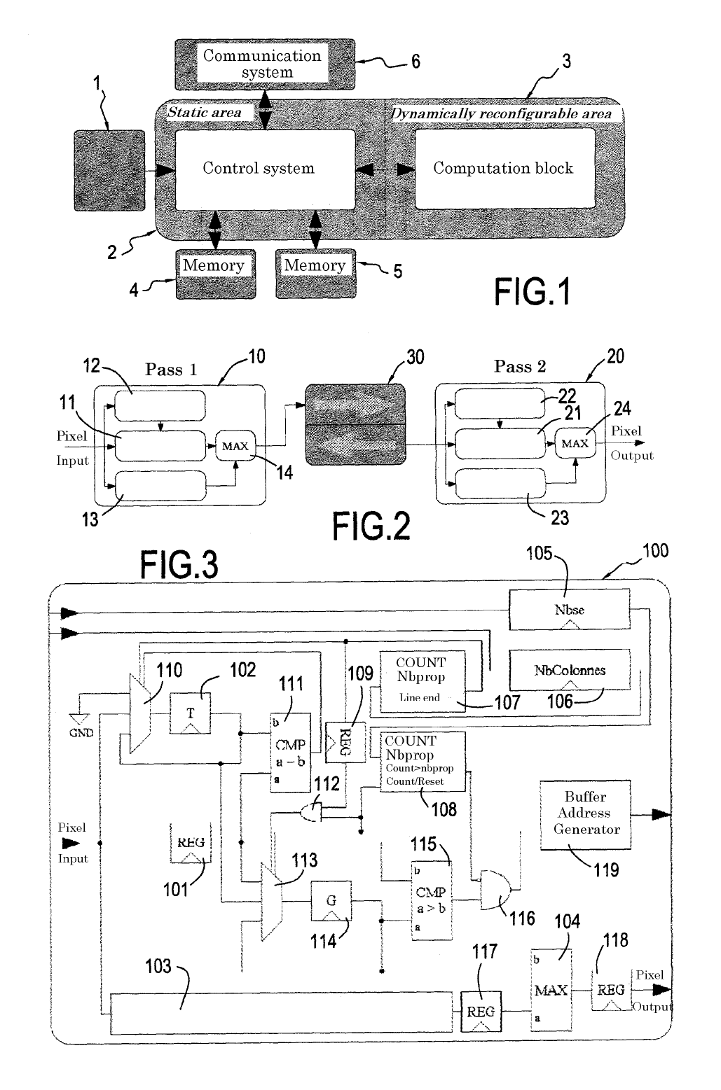

FIG. 1 is a block diagram of an image processing system of the invention;

FIG. 2 is a block diagram showing the structure of a morphological cell that performs processing in two passes;

FIG. 3 is a block diagram showing the structure of the elements constituting the first processing pass of the morphological cell from FIG. 2;

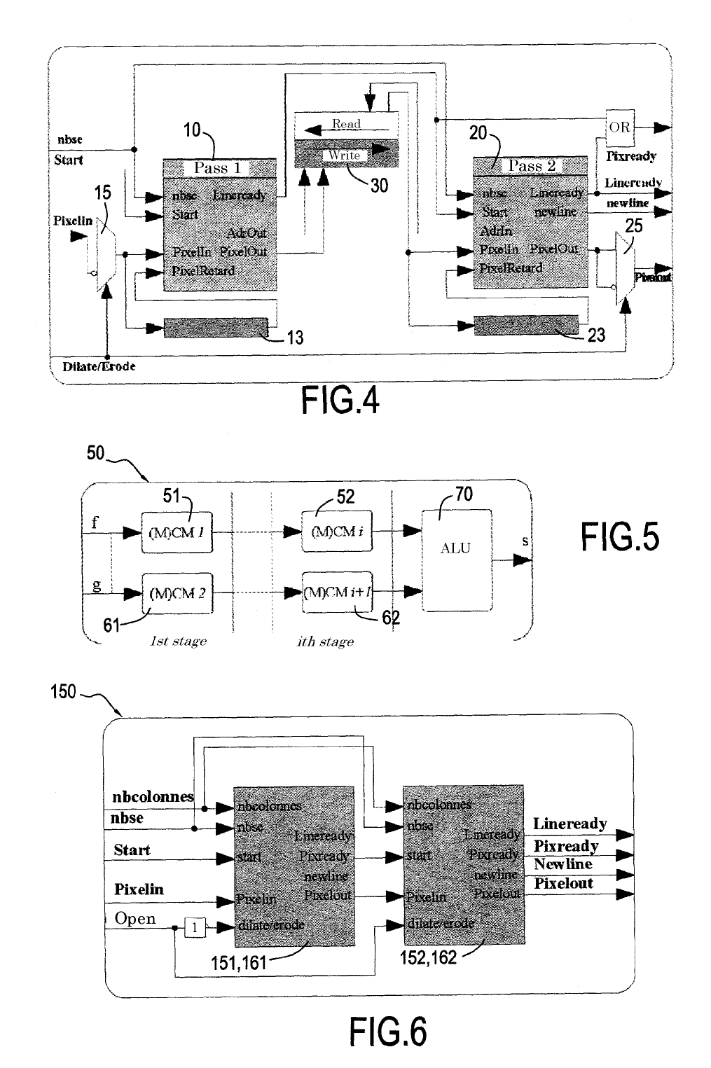

FIG. 4 shows the electronic structure of a morphological cell such as that from FIG. 2;

FIG. 5 shows the general architecture of a morphological macrocell (MMC);

FIG. 6 shows the electronic structure of a morphological macrocell performing the function of a dilation, erosion, open or close operator;

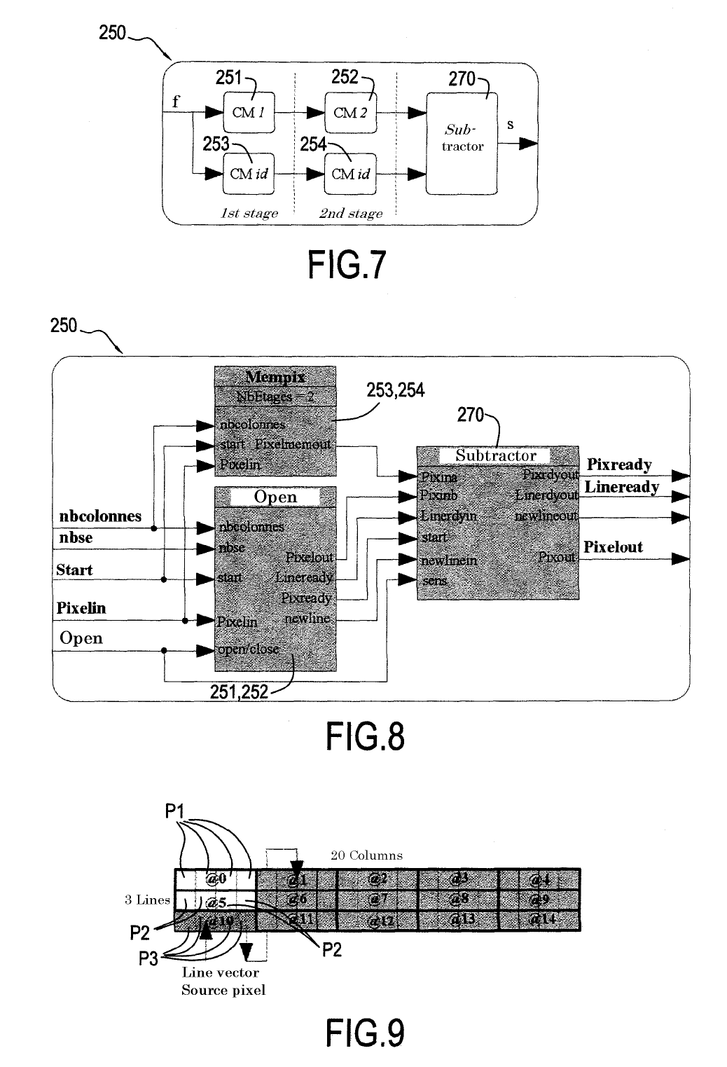

FIG. 7 shows the architecture of a morphological cell performing the function of a gradient, open, close, close top hat or open top hat composite operator;

FIG. 8 shows the electronic structure of a morphological macrocell performing the function of an open top hat operator;

FIG. 9 is a diagram showing the principle of line addressing of pixels in parallel;

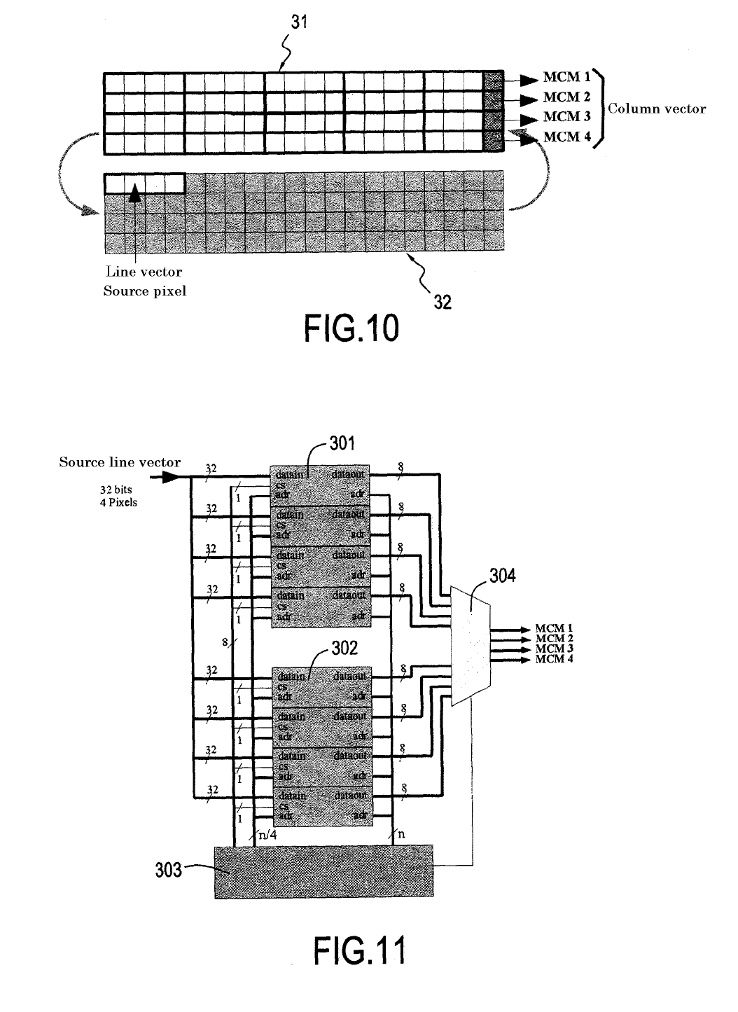

FIG. 10 is a diagram showing the principle of line/column transformation of pixel vectors;

FIG. 11 is a diagram showing the architecture of the line/column transformation system;

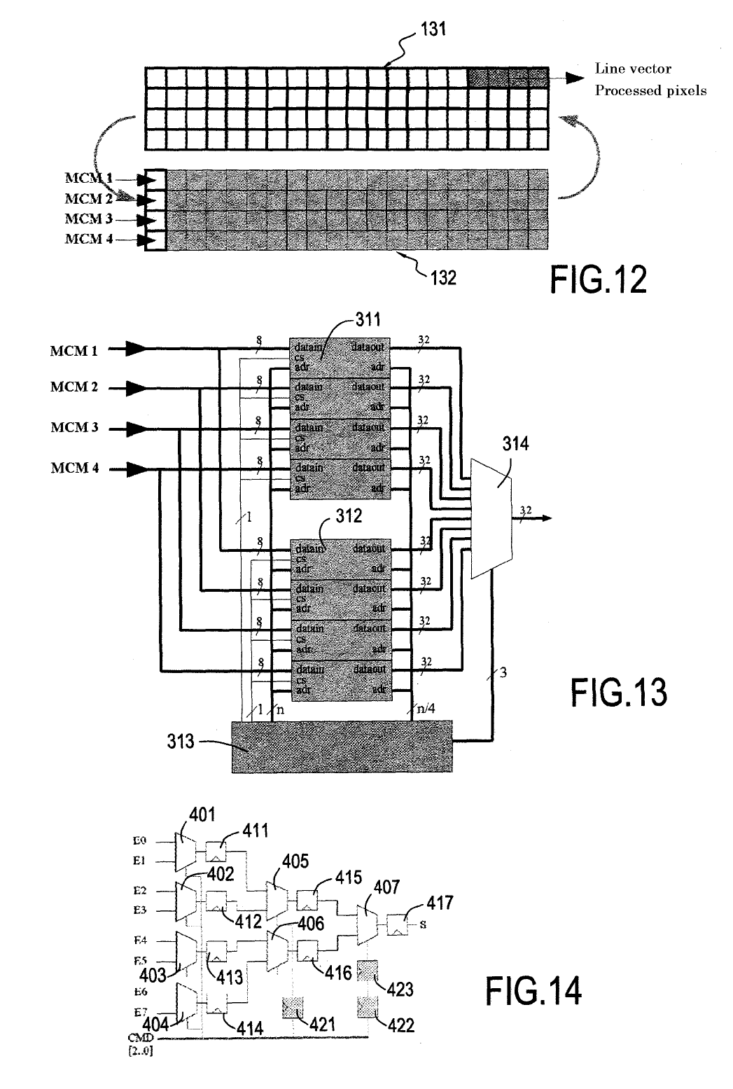

FIG. 12 is a diagram showing the principle of column/line transformation of pixel vectors;

FIG. 13 is a diagram showing the architecture of the pixel column/line transformation system;

FIG. 14 shows an example of a three-stage multiplexer usable in the FIG. 13 architecture;

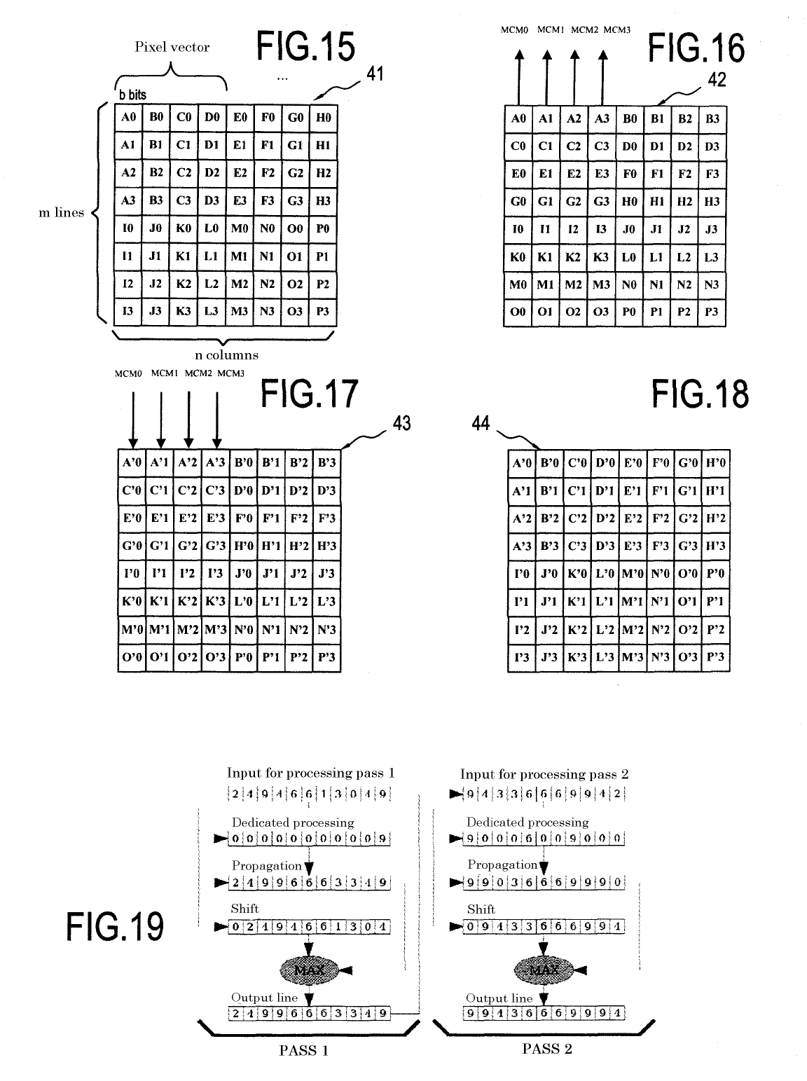

FIG. 15 shows an example of a source image;

FIG. 16 shows an example of an image at the output of a line/column parallelization buffer stage;

FIG. 17 shows an example of a computed image;

FIG. 18 shows an example of a computed image reorganized after column/line parallelization;

FIG. 19 shows the result of size 3 dilation by linear processing in constant time in two passes;

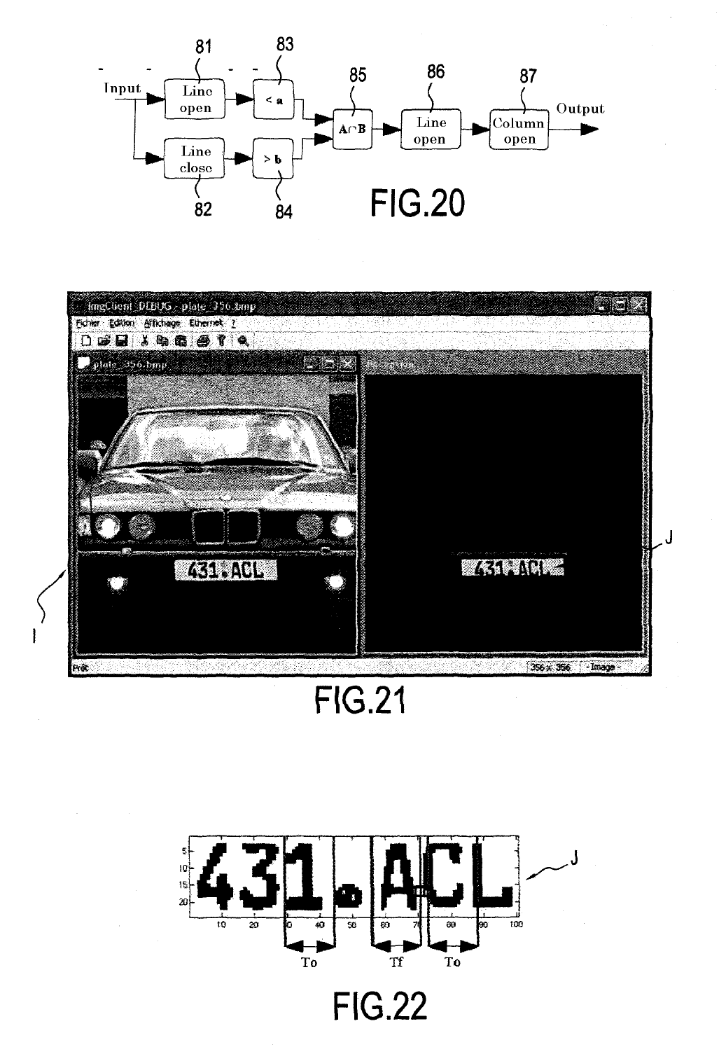

FIG. 20 is a block diagram showing the various steps of a method of detecting number plates using the architecture of the image processing system of the invention and an example of an image that can be subjected to number plate detection processing;

FIG. 21 is an example of an image obtained after processing the image from FIG. 20 by the method of the invention;

FIG. 22 is an enlarged view of the detected area from FIG. 21;

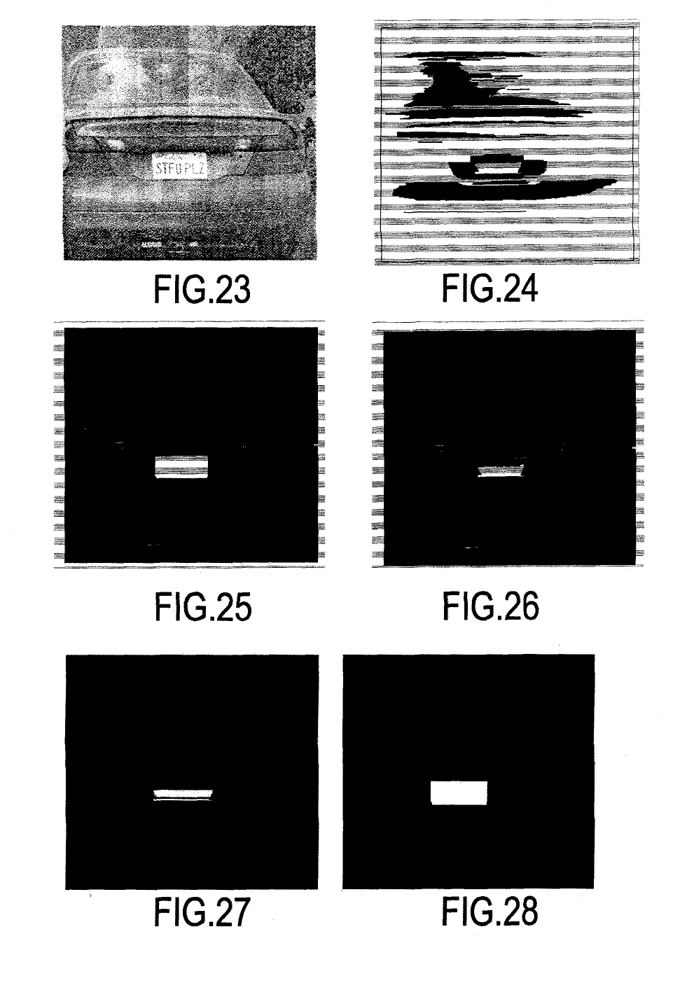

FIG. 23 is another example of an image subjected to number plate detection processing;

FIG. 24 is a processed image corresponding to the image from FIG. 23 on which an open function and a thresholding function have been executed horizontally;

FIG. 25 is a processed image corresponding to the image from FIG. 23 on which a close function and a thresholding function have been executed horizontally;

FIG. 26 shows a processed image corresponding to the intersection of the processed images from FIGS. 24 and 25;

FIG. 27 shows a processed image corresponding to the image from FIG. 26 after horizontal erosion and horizontal dilation;

FIG. 28 shows a processed image corresponding to the image from FIG. 27 after vertical erosion and vertical dilation, the white area indicating the position of the number plate;

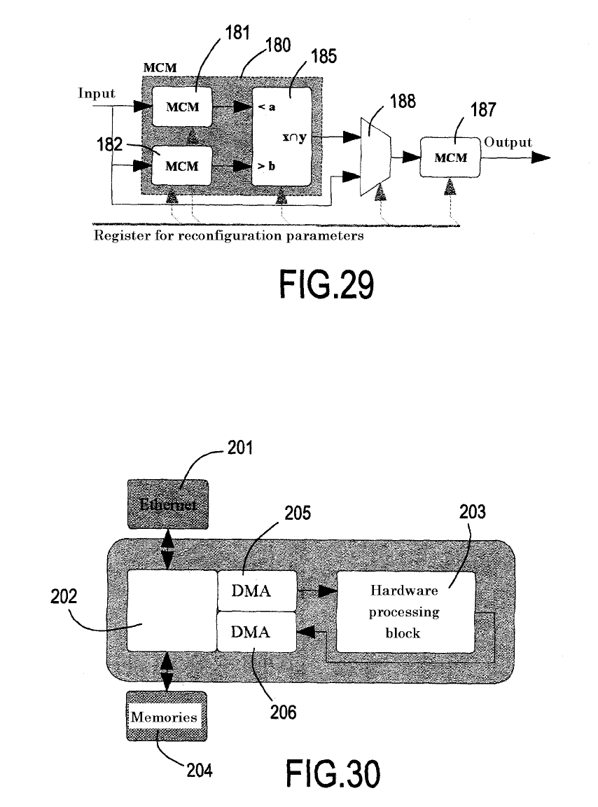

FIG. 29 is a block diagram showing the architecture of a number plate locating system; and

FIG. 30 is a block diagram showing an example of applying an image processing system to number plate detection.

FIG. 1 shows in block schematic form the main components of an image processing system of the invention with a sensor or image acquisition module 1, a control system 2 placed in a static area, a computation block 3 placed in a dynamically-reconfigurable area, memories 4, 5, and a communications system 6.

The image acquisition module 1 creates a grayscale digital image including a matrix of m lines and n columns coded on b bits (m, n, and b being integer numbers).

The control system 2 transfers data from the image acquisition system 1 to the memories 4, 5 or directly to the computation block. At the same time, the control system 2 manages the control of the stream to the computation block 3 and sends data with a dedicated address as a function of what is required. The computation block 3 is fed a data stream coming from the control system and need have no addressing function. In contrast, it is essential for the computation block 3 to be equipped with a mechanism for freezing the associated clock in order for the control system to be able to interrupt the data stream at any time and thereafter allow processing to resume without losing data.

The architecture of FIG. 2 therefore differs from that of a microprocessor and is closer to a systolic structure in which data from memory enters the computation units to be processed therein before being returned to memory.

Each of the computation units can be reconfigured between processing operations (type of processing, structuring element size, image size, arithmetic/logic unit function). Moreover, it is possible to create a plurality of data paths in order to apply different processing operations to an image.

By means of parallelization systems feeding the operators, using linear structuring elements makes it possible to perform processing on more than one line at a time.

There is described below with reference to FIGS. 2 to 4 a morphological cell that constitutes a basic component of the computation block 3 and enables linear dilation or erosion to be performed with a centered structuring element, a programmable element size, and a parameterable image size.

FIG. 2 shows the internal structure of a morphological cell constituting an operator.

The FIG. 2 morphological cell includes first and second units 10, 20 that perform two processing passes.

Each of the first and second units 10, 20 includes three main components, namely:
a propagation unit 11, respectively 21;
a unit 12, respectively 22, for managing edge effects and dedicated processing;
a delay line 13, respectively 23.
The units 10, 20 further include a maximum detection comparator circuit 14, 24.

There is a buffer module 30 between the units 10 and 20.

A processing pass in the first unit 10 or the second unit 20 proceeds in three stages.

In a first stage, the output of the dedicated processing unit 12, 22 is computed so that the propagation unit 11, 21 can take account of edge effects. In a second stage, the propagation unit 11, 21 propagates the pixels as a function of their value, the size of the structuring element, and the output from the dedicated processing unit 12, 22. In a final stage, the propagation result is compared in the circuits 14, 24 with the source pixels stored in the delay line 13, 23 and the greater of the two is retained.

FIG. 3 shows in more detail an embodiment 100 of the first unit 10 performing a first pass.

The unit 100 represented in FIG. 3 has a pixel input that is connected to an input circuit 110 of the unit for managing edge effects and dedicated processing, to a register 101 itself connected to an input circuit 113 of the propagation unit, and to a delay line 103.

A register 105 stores the value Nbse corresponding to half the size of the structuring element.

A register 106 stores a value NbColumns corresponding to the number of columns to be processed in a computation line.

The output of the register 106 is connected to the input of a counter 107 having an end of line output connected firstly to the circuit 110 and secondly to the circuit 113 via a delay register 109 and a logic gate 112.

The output of the register 105 is connected to the input of a counter 108 an output of which is connected to the input of a logic gate 116 another input of which is connected to the output of a comparator circuit 115. The output of the logic gate 116 is also connected to the circuit 113.

The unit for managing edge effects and dedicated processing has at its output a register 102 that stores a value T corresponding to the result of the dedicated processing of edge effects.

The propagation unit includes a register 114 that stores a value G that is thereafter fed to an input of the comparator 115 and to an input of the comparator 104 for determining a maximum.

The output of the delay line 103 is connected to a register 117 that is itself connected to another input of the comparator 104, the output of which is connected via a register 118 to the pixel output.

The outputs of the registers 101 and 102 are connected to the inputs of the comparator 111, the output of which is connected to the circuit 110.

A reset input of the counter 108 is connected to an input of the logic gate 112 and to the output of the logic gate 116.

The unit 100 further includes a buffer circuit address generator 119

Although processing a pixel takes three clock cycles, this pipeline structure is capable of processing one pixel per cycle.

The value of T is computed in the first cycle. This value is then sent to the propagation unit. G is computed in the second cycle. To guarantee the rate of one pixel per cycle, care must be taken to work with the input pixel that corresponds to the value of T generated on the first cycle. This is why G is fed with an input pixel value delayed by one cycle (by the register 101). On the third cycle, the greater of the output G of the register 114 and the output of the register 117 associated with the delay line 103 is computed. The delay line 103 must have a size of NbSe+2 because it must take the two preceding cycles into account to compute G.

The unit that performs the second pass is almost identical to the unit 100 that has just been described. The only differences are in the computation that is performed by the dedicated unit on all the pixels of a line and in the address generator 119 that generates a buffer read address rather than a write address.

To have a data structure enabling a large and configurable delay, a dual port memory can be used.

The input pixel write address is at zero during the operator initialization phase and the read address is the address indicated by the value of the register Nbse. On each clock cycle, the addresses are incremented so that there is always a different value of Nbse+1 between addresses. To satisfy the constraints of pipeline working, which imposes a delay of Nbse+2, there is an additional register at the output of the memory. This register can be included in the memory to guarantee a higher operating frequency.

The objective is to create a totally pipelined data stream operator. It is necessary for the processing passes to be executed at the same time.

The two units 10, 20 cannot process the same line at a given time because a line is processed in both directions. The first pass processes a line from left to right and the second pass uses the result of the first pass but with scanning from right to left. So as not to stop the pipeline during the processing of a line, it is then necessary to use a buffer 30 consisting of two memories that are interchanged on each arrival at the operator of a new line (this is known as “ping pong” mode).

Accordingly, at a given time, when the first pass unit 10 is processing the line “n”, the second pass unit 20 is processing the line “n−1”. The write addresses of the buffer 30 (for the first pass) and the read addresses of the buffer 30 (for the second pass) are managed by the address generators of each of the units 10, 20.

FIG. 4 shows the complete architecture of a basic morphological cell operator. This embodiment employs the following signals:
Inputs:
“Nbse”: size of the structuring half-element;
“Start”: when at 1, indicates that processing must start;
“Pixelin”: pixels to be processed;
“Dilate/erode”: indicates if dilation or erosion is to be performed.

An “enable” input, not shown, enables processing to be frozen when this signal is at zero.
Outputs:
Pixready”: indicates, on going to 1, that the pixelout output is valid;
“Lineready”: indicates that the first line has been processed;
“newline”: goes to 1 on each new line processed;
“pixelout”: pixel processed.

In FIG. 4, the pixel input and pixel output circuits are identified by the references 15 and 25, respectively, and the delay lines of the units 10 and 20 by the references 13 and 23, respectively.

According to the invention, the computation block uses morphological macrocells (MMC) which themselves comprise a plurality of basic morphological cells (MC) like that described above and can thus produce composite operators, such as a morphological gradient operator, an open operator, a close operator, a close top hat operator or an open top hat operator, from basic erosion, dilation and identity morphological cells.

FIG. 5 shows diagrammatically the architecture of a morphological macrocell 50 that can have a first branch f with a plurality of morphological cell stages 51, 52 and a second branch g in parallel also with a plurality of morphological cell stages 61, 62.

The morphological cells 51, 52 or 61, 62 are designed to be pipelined.

Note that the morphological cells 51, 52, 61, 62 can themselves be replaced by morphological macrocells to produce new morphological macrocells constituting operators more complex than those already referred to. The more complex operators are always produced by placing basic operators “end to end”, producing a structure that is relatively simple to construct.

In the FIG. 5 architecture, the morphological cells 51, 52, 61, 62 execute erosion, dilation and identity functions using linear structuring elements.

Note that all morphological cells or morphological macrocells of the same stage (for example the cells 51 and 61 or the cells 52 and 62) must have the same latency for pipeline operation to enable combination of their results, for example in the arithmetic and logic unit 70.

The functionality of each morphological cell 51, 52, 61, 62 and the size of the structuring elements are programmable dynamically and the parallel streams from the basic morphological cells 51, 52, 61, 62 of the branches f, g are recombined at the output by an arithmetic and logic unit 70.

The basic morphological cells 51, 52, 61, 62 and the morphological macrocells 50 have a control mechanism that can communicate with the control system to stop processing selectively as a function of the availability of the data and thereafter to resume processing without losing data in the pipeline.

FIG. 6 shows the electronic structure of a morphological macrocell 150 producing an open operator.

Under such circumstances, the morphological cells 151, 161 of a first stage perform erosion and the morphological cells 152, 162 of a second stage perform dilation. Note that the electronic structure of a morphological macrocell producing a close operator would be similar, but the morphological cells 151, 161 of a first stage would then perform dilation and the morphological cells 152, 162 of a second stage would perform erosion.

FIG. 7 shows the general architecture of a morphological macrocell 250 producing a top hat operator.

Under such circumstances, a first branch f comprises morphological cells 251, 252 which execute an open or a close function, depending on whether they perform erosion and then dilation or dilation and then erosion.

A second branch comprises identity morphological cells 253, 254.

There is a subtractor 270 at the output of the morphological macrocell 250.

Accordingly, the morphological macrocell 250 takes as its input stream an image, in fact an open or close function (cells 251 and 252), and subtracts the output of the stream from the cell 252 with the output of the stream from the cells 253 and 254 representing the identity function.

This executes either the open top hat function or the close top hat function. The processing sequence, i.e. the chaining of the cells 251 and 252, must relate to the subtraction direction (if the cell 251 performs erosion and the cell 252 performs dilation, which represents an open function, the output of the cell 252 must be subtracted from the output of the identity cell 254).

FIG. 8 shows the electronic structure of the morphological macrocell 250 of the top hat operator.

A component “Mempix” performs the role of the cells 253, 254 and constitutes the identity operator to which is specified the number of stages to be covered (two stages here). The component “Mempix” can thus be used very easily in a morphological macrocell of variable length.

The data parallelization system for parallel processing of a plurality of lines, respectively a plurality of columns, is described more particularly next.

Using linear structuring elements makes parallel computation relatively simple. Each line of the image is independent of the others, which enables a plurality of lines to be processed at the same time. This parallelization can be effected only if the source image stream is made up of a plurality of pixels on each clock pulse.

The pixel vector is generally a line vector. It is therefore necessary to effect a transformation on the pixels to obtain a column vector in the situation of line processing. If the source pixel vector is a column vector, it must be transformed into a line vector to perform column processing.

In the situation of column processing with pixel line vectors, the system that manages the sending of the video stream is considered to be capable of managing line addressing rather than column addressing, as FIG. 9 shows. (In the situation of line processing with column pixel vectors, column addressing must be adopted). In this FIG. 9, the pixels P₁, P₂ represent the pixel vectors already sent, the pixels P₃ the pixel vectors being sent, and the remaining pixels the pixel vectors to be sent. The address value in this type of addressing is incremented by one line size on each clock pulse. This type of processing dispenses with the use of line/column and column/line transformation.

To conform to the systolic structure of the architecture of the invention, the line/column and column/line transformations must be performed in the stream.

FIG. 9 shows an example with 3 lines and 20 columns, but these numbers can naturally be different.

In FIGS. 10 to 18 a pixel line vector of size 4 is considered. In the situation of line processing, computation is therefore performed four lines at a time.

FIG. 10 shows the principle employed. In a first stage, the buffer 31 is filled with the pixels to be processed. The memories are filled successively, i.e. when the first memory is full, the process moves on to the next memory. As soon as the four memories are filled, this operation is continued in the buffer 32 and at the same time one pixel per line is recovered from the buffer 31 on each clock pulse. Once the system has been initialized, four pixels per line are written and four pixels per column are read each time and are sent to four morphological macrocells MCM1, MCM2, MCM3, MCM4.

FIG. 11 shows the architecture of a pixel line/column transformation system, with by way of example a source line vector of four pixels of 32 bits.

A circuit 303 constitutes an address generator and selects memories associated with the buffers 301 and 302 and the multiplexer 304.

The architecture employed in the FIG. 11 example consists of eight memories with a size of one line that constitute the buffers 301 and 302. Each memory has two ports: an input port on 32 bits and an output port on 8 bits. To fill the eight memories sequentially, the “chipselect” inputs are commanded independently. The pixels are read from packets of four memories to recover the pixel column vector.

The addresses are incremented continuously and their values indicate when to select a memory and how to configure the multiplexer 304.

The outputs of the multiplexer 304 are therefore fed directly to four identical morphological macrocells MCM1, MCM2, MCM3, MCM4 that process four lines at a time. However, an analogous structure is required to reconstruct the original data (still in the stream).

FIG. 12 shows column/line transformation of the pixel vectors with buffers 131, 132.

The column/line transformation is analogous to the line/column transformation, except that pixels from different lines are received and line pixels are sent back to the system that sent the original image. FIG. 12 shows the general principle of this transformation. An input column vector of four pixels and an output line vector of four pixels are considered here.

As in the previous transformation, at any given time there are four pixels entering the buffer 131 or 132 and four pixels leaving the buffer 132 or 131.

FIG. 13 shows the architecture used. The four pixels from the morphological macrocells MCM1, MCM2, MCM3, MCM4 are written in each line of the buffer 311 or 312. The four pixels are read sequentially in each of the memories of the buffer 312 or 311. The “chip select” inputs managing the writing of the processed pixels command the memories in packets of four, because it is necessary to write the pixels in each line (see above). The addresses are incremented continuously and the memory for the outgoing pixels is selected by an 8*32-bit to 32-bit multiplexer 314.

The circuit 313 is an address generator and memory selector circuit.

Note that a multiplexer such as the multiplexer 314 can be produced in pipeline form with three stages, as represented in FIG. 14, with registers 411 to 417 in each stage associated with the basic multiplexers 401 to 407 to delay the commands at each stage and to guarantee that the system functions correctly.

In FIG. 14, the first stage therefore comprises the multiplexers 401 to 404 whose outputs are associated with the registers 411 to 414, the second stage comprises the multiplexers 405, 406 whose outputs are associated with the registers 415, 416, and the third stage comprises the multiplexer 407 whose output is associated with the register 417.

A register 421 produces a delay for the second stage relative to the first stage and registers 422, 423 produce a double delay for the third stage relative to the first stage.

FIGS. 15 to 18 show one particular example of the operation of the parallelization system used by the present invention.

FIG. 15 shows a source image 41 with m lines and n columns (8 lines and 8 columns in the example shown) and a pixel vector of b bits (4 bits A0, B0, C0, D0 in the example shown).

FIG. 16 shows the image 42 at the output of the parallelization buffer after line/column parallelization.

Four bits A0, A1, A2, A3 are sent in parallel to four morphological macrocells MCM0, MCM1, MCM2, MCM3.

FIG. 17 shows a computed image 43 with four input bits A′0, A′1, A′2, A′3 in parallel coming from the four morphological macrocells MCM0, MCM1, MCM2, MCM3.

FIG. 18 represents the computed image 44 reorganized after column/line parallelization based on the computed image from FIG. 17.

Thus the lines of the image are processed independently. In each clock cycle four pixels of the source image 41 are available (FIG. 15). The parallelization system uses parallelism to process a plurality of lines at once. The pixels are sent in line vector form (for example: {A0, A1, A2, A3}). These four pixels can then be processed as a data stream by the four morphological macrocells present in the circuit (FIG. 16). At the output from the morphological macrocells, the opposite transformation is effected in order to reorganize the pixels as in the source image (FIGS. 17 and 18).

To explain more clearly the optimized constant time processing effected in a basic morphological cell, such as the morphological cell 50 from FIG. 2, which comprises a buffer 30 and two function units 10, 20 for processing the pixels of an image in two passes, there is shown in FIG. 19 the result after a first computation pass and then after a second computation pass in an example of dilation by a linear structuring element of size 3.

In the context of constant time linear processing relative to the size of the window used, executed in two almost identical passes, a scan is effected in the forward direction (from left to right) for the first pass and in the reverse direction for the second pass. Each of the passes processes propagation of pixels and edge effects as a function of the size of the structuring element and the size of the line. The passes differ in how they process edge effects. The first pass processes edge effects at the end of a line and the second pass propagates edge effects continuously in the line.

The computation is performed in the following manner:
Computation of the value g(x) of propagation of the input pixels to n pixels (where N=2n+1 represents the size of the structuring element), according to the condition:

$$g ( x ) = \{ \begin{matrix}g ( x - 1 ) & if g ( x - 1 ) > f ( x ) and k < n \\ f ( x ) & else\end{matrix}$$

where k is the propagation index.

Processing edge effects enables storage of the pixels to be taken into account in subsequent propagations in the same line. Values can be “forgotten” during propagation, and must then be taken into account to reinject them afterwards.

The output pixel value of a pass is computed as follows:

s(x)=max(g(x), f(x−n)).

In the FIG. 19 example, N=3 and the offsetting and propagation size are therefore effected with a size of n=1 pixel (relative to the formula mentioned above).

Note also that in order for processing to be centered it is necessary to effect the second pass in the opposite direction to the first pass (to be able to propagate the pixels in the other direction).

Because the two passes are not entirely equivalent in the dedicated processing unit, it is not possible to construct processing operations with non-centered linear structuring elements using a different size of n for each of the two passes.

For an image consisting of K lines and L columns, the complexity in terms of the number of min/max is 2·K·L.

Note that this complexity is independent of the size of the structuring element.

To perform processing with a rectangular window, it is necessary to perform a second processing operation, this time on the columns of the image. A square structuring element can be broken down into two perpendicular linear structuring elements.

For example, in a system of the invention, more than 2 500 images per second can be processed with a parallelized top hat operator. This processing time is independent of the size of the structuring element, which makes the system completely predictive.

The image processing system of the invention can be applied to video surveillance and in particular to detecting objects carrying repetitive patterns consisting of letters, digits or symbols, for example number plates.

Applying the image processing system of the invention to detecting a text with a given resolution uses only linear structuring elements for processing.

The signal generated by the presence of the repetitive patterns (letters, digits, symbols) indicates their periodic nature. Searching for and identifying this periodic character of the signal detects in a wider image the position of a number plate containing these symbols.

FIG. 21 shows by way of example, on the left, an image I to be processed, which is a view of the front of an automobile, and on the right an image J that is the result of processing and where only the number plate J from the original image I can be seen.

FIG. 20 shows the general structure of the image processing system of the invention applied to detecting number plates.

The input signal is applied to two processing branches in parallel, one comprising a line open module 81 followed by a threshold module 83 for a value a and the other comprising a line close module 82 followed by a threshold module 84 for a value b.

The outputs of the threshold modules 83, 84 are fed to an intersection module 85 followed by a line open module 86 followed by a column open module 87.

In order to be able to process all image sizes, the various morphological modules have parameters that can be set accordingly. The structuring element size chosen is a function of the resolution of the image. The larger the image, the more pixels there are for representing a number plate.

FIG. 22 shows the number plate from FIG. 21 enlarged. The alternation of black and white pixels enables the number plate J to be identified in the image I.

For what now follows, the pseudo-period To, Tf is defined as the distance of the repetitive patterns at a given resolution.

Starting with an example of an original image such as that from FIG. 23, in a first stage it is necessary to execute an open function with a linear structuring element (SE) the size of a pseudo-period “To” to eliminate the white areas from the image (FIG. 24). The effect of this is to propagate the dark values of the image. The white areas will therefore be partly eliminated from the number plate. Thus the characters will no longer be distinguishable. It is then necessary to execute the same function with a size “Tf” but executing a close function on the original image (FIG. 25). The effect of this is to propagate the pale values of the image.

In the example represented here, the sizes of the structuring elements SE are determined by the length of the pseudo-periods To and Tf and are approximately equal to 15, but a size 30 is used so as not to be bothered with low characters, the original image in this example being of VGA size (640×480 pixels).

In a second stage, each stream is binarized. In the stream on which the open function was executed, pixels with a value below the value a of the pixels of the characters are set to 1. For the close function, the pixels that have a value greater than the value b of the pixels of the area around the characters are set to 1. The intersection of these two streams is then computed to obtain the FIG. 26 image.

Note the presence in the FIG. 26 image of irrelevant small white areas. They can be eliminated by executing a line open function for short areas and a column open function for low areas. These functions can be executed using a larger structuring element for dilation than for erosion. It is in fact erosion that captures the useful information from the image and dilation that restores the normal size of the area of interest. Using a larger dilation ensures that the area of interest is covered correctly.

The FIG. 27 image was obtained by executing, in the horizontal direction, size 60 erosion followed by size 80 dilation. Note that this operation can degrade the relevant area. It is therefore necessary to effect the same processing in the vertical direction to correct this deterioration and to eliminate remaining irrelevant areas. The resulting image (FIG. 28) shows that the relevant area is now covered correctly.

The thresholds are also configurable. This is why preprocessing, such as contrast enhancement, can be applied to simplify adjusting them.

The thresholds can be adjusted iteratively. As processing is fast, it is possible to conceive of testing a plurality of different thresholds until a number plate is found in the image. At a given resolution, a number plate almost always has the same area if the observation point does not change, as with roadside radar.

Another important point to mention is having to execute a vertical open function, because it is then necessary to rotate the image 90° to be able to use the optimized constant time erosion/dilation algorithm.

The architecture adopted uses for the open/close functions morphological macrocells 181, 182 like those described above and a computation unit 185 that performs thresholding and stream intersection.

After intersection, a line open function and then a column open function are computed. The column open function can be computed only when all of the image has been processed; thus it cannot be chained directly in the processing. The processing is therefore divided into two phases:
1^{st} phase: image line processing (open/close, thresholding, intersection, open)
2^{nd} phase: image column processing (open).

Starting the second phase processing presupposes that the first phase processing has been completed. This means that the resources of the architecture can be shared. It is therefore possible to use the last line open function of the first phase again to perform the column open function of the second phase, modifying the data path. This modification is possible because all the parameters of the morphological macrocells (structuring element size, image size, type of processing, etc.) are stored in registers. At the end of the first phase, the data path is modified and the registers are loaded with the new values (change of image size, because it is rotated 90° or 270°, and structuring element size).

FIG. 29 shows the architecture of the system described above. Note the presence of a multiplexer 188 for modifying the data path, which is controlled by the system managing sending and receiving the video stream. The parameter registers are also controlled by the management system. At the end of the first phase, the multiplexer 188 and the registers are loaded with the new column processing parameters. Processing is relaunched with this new architecture configuration and the image that is received corresponds to the final image of the processing.

The processing architecture is therefore reconfigurable because the parameters of the morphological macrocells, including the morphological macrocell 187 that can execute a line open function in a first phase and a column open function in a second phase, and the data path can be modified during processing.

FIG. 30 shows by way of example a functional view of a number plate detection system.

The image to be processed can be sent via a network 201 such as an Ethernet network.

A processor 202 stores the image received in memories 204.

Direct memory access units 205, 206 are configured by the processor 202 to send the original image and to receive the image processed by the hardware processing block 203. Once processing has been completed, the image is sent via the Ethernet network 201 for observation of the result.

The memory of the processor 202 cannot send pixels to be processed in all clock cycles because the memory bus is shared with other components of the processor. The number plate detection architecture can handle this problem without difficulty because processing can be frozen at any time.

The operating frequency can be 50 MHz, for example, enabling a 356×356 image to be processed in 15 ms.

1. An image processing system using morphological macrocells, characterized in that it comprises:
an image acquisition device for creating a grayscale digital image including a matrix of m lines and n columns coded on b bits, where m, n, and b are integers;
a set of memories;
a dynamically reconfigurable computation block for performing image processing, the computation units and the data paths being reconfigurable during execution between individual processes; and
a control system for transferring data between the image acquisition device and the set of memories and for managing the control of p parallel streams of data to the computation block and sending of the data with dedicated addresses as a function of the requirements of the block, where p is an integer;
in that the computation block includes:
an integer number k greater than 1 of morphological macrocells each including a set of basic morphological cells organized into b parallel branches (f, g) with an integer number e of stages, each cell performing a basic erosion, dilation or identity function based on the use of linear structuring elements, the functionality of each morphological cell and the size of the structuring elements being programmable dynamically and the parallel streams coming from the basic morphological cells being combined at the output by an arithmetic and logic unit;
at least one system for parallelizing the data for processing a plurality of lines, respectively a plurality of columns, in parallel, including two buffer modules and a demultiplexer pipelined over a set of s synchronous stages to break down a word into p parallel data streams and connected to the p inputs of the morphological macrocells (MCM1, MCM2, MCM3, MCM4); and
at least one system for reconstructing the image from an integer number z of parallel output streams of the k morphological macrocells, including two buffer modules and a multiplexer pipelined over a set of s′ stages and connected to synchronous outputs of the morphological macrocells;
and in that the basic morphological cells and the morphological macrocells are provided with a control mechanism able to communicate with the control system to stop selectively execution of processing as a function of the availability of the data and thereafter to resume processing without losing data in the pipeline.

2. A system according to claim 1, characterized in that it includes an integer number f of data parallelization systems and image reconstruction systems to enable processing over f×p parallel streams of data.

3. A system according to claim 1, characterized in that the morphological macrocells are pipelined over a plurality of branches with a plurality of stages, the outputs being combined by an arithmetic and logic unit.

4. A system according to claim 1, characterized in that each morphological cell includes first and second processing units for carrying out processing in first and second passes in different processing directions and in that there is a buffer module between the first and second processing units.

5. A system according to claim 4, characterized in that the first and second processing units each include a propagation unit, an edge effect and dedicated processing management unit, and a delay line.

6. A system according to claim 1, characterized in that at least one morphological macrocell includes a morphological cell performing erosion followed by a morphological cell performing dilation to define an open operator.

7. A system according to claim 1, characterized in that at least one morphological macrocell includes a morphological cell performing dilation followed by a morphological cell performing erosion to define a close operator.

8. A system according to claim 1, characterized in that at least one morphological macrocell includes a morphological cell performing an identity function.

9. A system according to claim 6, characterized in that at least one morphological macrocell includes first and second morphological cells for executing erosion and dilation functions, third and fourth morphological cells for executing the identity function, and a subtractor for creating a top hat open operator or a top hat close operator.

10. Use of a system according to claim 6, including at least two chained morphological macrocells combined with arithmetic/logic units to perform image processing operations such as gradient, non-linear filter, alternating sequential filter, and contrast modification operations.

11. A system for detecting objects carrying repetitive patterns consisting of letters, digits or symbols;
characterized in that it includes a reconfigurable image processing system according to claim 1 using morphological macrocells, a first image processing module and a second image processing module.

12. A system according to claim 11, characterized in that the first image processing module includes a first open/close module, a second open/close module, an arithmetic/logic unit for performing comparisons with thresholds, an intersection module, and a line open module.

13. A system according to claim 11, characterized in that the second image processing module includes an open/close module.

14. A system according to claim 11, characterized in that it is applied to detecting number plates.

15. A system according to claim 2, characterized in that:
the morphological macrocells are pipelined over a plurality of branches with a plurality of stages, the outputs being combined by an arithmetic and logic unit;
each morphological cell includes first and second processing units for carrying out processing in first and second passes in different processing directions and in that there is a buffer module between the first and second processing units;
the first and second processing units each include a propagation unit, an edge effect and dedicated processing management unit, and a delay line;
at least one morphological macrocell includes a morphological cell performing erosion followed by a morphological cell performing dilation to define an open operator;
at least one morphological macrocell includes a morphological cell performing dilation followed by a morphological cell performing erosion to define a close operator;
at least one morphological macrocell includes a morphological cell performing an identity function;
at least one morphological macrocell includes first and second morphological cells for executing erosion and dilation functions, third and fourth morphological cells for executing the identity function, and a subtractor for creating a top hat open operator or a top hat close operator; and
it further includes at least two chained morphological macrocells combined with arithmetic/logic units to perform image processing operations such as gradient, non-linear filter, alternating sequential filter, and contrast modification operations.

16. A system for detecting objects carrying repetitive patterns consisting of letters, digits or symbols;
characterized in that it includes a reconfigurable image processing system according to claim 15 using morphological macrocells, a first image processing module and a second image processing module.

17. A system according to claim 12, characterized in that it is applied to detecting number plates.

18. A system according to claim 13, characterized in that it is applied to detecting number plates.
